(19) United States
(12) Patent Application Publication
(10) Pub. No.: US 2025/0308098 A1
(43) Pub. Date: Oct. 2, 2025

(54) IMAGING METHOD HAVING ENHANCED COLLISION PREDICTION AND IMAGING DEVICE

(71) Applicant: GE Precision Healthcare LLC, Waukesha, WI (US)

(72) Inventors: Ziyu Liu, Beijing (CN); Ziqiang Du, Beijing (CN); Feng Li, Beijing (CN); Xinyuan Wang, Beijing (CN); Bingjie Zhao, Beijing (CN)

(21) Appl. No.: 19/093,990

(22) Filed: Mar. 28, 2025

(30) Foreign Application Priority Data
Mar. 29, 2024 (CN) 202410381080.3

(51) Int. Cl. G06T 11/00; G06T 5/20; G06T 7/00; G06T 7/215; G06T 7/73

(52) U.S. Cl. CPC G06T 11/005; G06T 5/20; G06T 7/0012; G06T 7/215; G06T 7/74; G06T 11/008; G06T 2207/10081; G06T 2207/20076; G06T 2207/30004

(57) ABSTRACT

Provided are an imaging method and an imaging device. The imaging method includes: obtaining a global 3D contour image including an imaging device and a pre-identified object, where the pre-identified object includes at least a part of a subject under examination; predicting a potential collision pixel at which the pre-identified object will possibly collide with the imaging device in a process of being moved; obtaining a contour image of the subject under examination; determining whether the potential collision pixel falls within a range of the contour image of the subject under examination; and in response to the aforementioned determination, generating a corresponding imaging operation prompt.

### CROSS-REFERENCE TO RELATED APPLICATIONS

This application claims priority to Chinese Application No. 202410381080.3, filed on Mar. 29, 2024, the disclosure of which is incorporated herein by reference in its entirety.

### TECHNICAL FIELD

The present disclosure relates to the field of non-destructive examination, and more particularly, to a method for predicting collision between a subject under examination and an imaging device in a non-destructive examination process, and an imaging device.

### BACKGROUND

Generally, examination may be performed by using a non-destructive examination method. During examination, a subject under examination may collide with an examination apparatus when a scanning table moves. Therefore, a method for predicting such a collision is provided. For example, as shown in FIG. 15, if the hand of a person under examination remains stationary, the hand will collide with a scanner gantry. In order to avoid the occurrence of such a collision accident, it is desirable to predict such a collision.

However, in an actual operation, a predicted collision region not only includes a collision between a subject under examination and an examination apparatus, but may include noise caused by an accessory other than the subject under examination colliding with the examination apparatus or caused by another object (e.g., an examination operator) in the vicinity of the subject under examination. This leads to an inaccurate collision prediction result, and inaccurate collision prediction leads to a decrease in examination efficiency.

Therefore, there is a high necessity for a technique capable of accurately predicting a collision between a subject under examination and an imaging apparatus while excluding other interference factors.

### SUMMARY

The objective of the present invention is intended to overcome the above-mentioned and/or other problems in the prior art. According to the present invention, a method for predicting a collision between a subject under examination and an imaging apparatus, and an imaging apparatus capable of implementing such prediction are provided, which can predict with high accuracy whether the subject under examination will collide with the imaging apparatus while completely excluding interference factors such as accessories and “noise”, thereby effectively ensuring that the imaging apparatus scans and images the subject under examination efficiently and safely.

According to a first aspect of the present invention, an imaging method is provided, comprising: obtaining a global 3D contour image including an imaging device and a pre-identified object, wherein the pre-identified object comprises at least a part of a subject under examination; predicting a potential collision pixel at which the pre-identified object will possibly collide with the imaging device in a process of being moved; obtaining a contour image of the subject under examination; determining whether the potential collision pixel falls within a range of the contour image of the subject under examination; and in response to the aforementioned determination, generating a corresponding imaging operation prompt.

In an embodiment, the pre-identified object further includes an accessory of the imaging device.

In an embodiment, the method may further include determining a scan range of interest from the global 3D contour image, wherein the scan range of interest includes at least a region of interest of the subject under examination, wherein the potential collision pixel is predicted only for the scan range of interest in the global 3D contour image.

In an embodiment, predicting the potential collision pixel includes converting coordinates of the pre-identified object from a coordinate system of a camera to a coordinate system of the imaging device; and determining, based on coordinates of the pre-identified object after conversion and movement plan information of the subject under examination, whether the pre-identified object will overlap with a 3D contour of the imaging device in a process in which the pre-identified object is moved according to the movement plan information, wherein the 3D contour of the imaging device is obtained from the imaging device.

In an embodiment, the method may further include in response to determining that the potential collision pixel does not exist or the potential collision pixel does not fall within the range of a 2D contour image of the subject under examination, moving the subject under examination based on the movement plan information.

In an embodiment, determining whether the potential collision pixel falls within a range of the contour image includes extracting a 2D contour image of the subject under examination from the global 3D contour image; projecting the potential collision pixel onto the same 2D plane as the 2D contour image; and determining whether a projection of the potential collision pixel on the 2D plane falls within a range of the 2D contour image of the subject under examination.

In an embodiment, extracting a 2D contour image of the subject under examination includes obtaining a global 2D contour image in the global 3D contour image; determining, based on a probability value that each pixel in the global 2D contour image belongs to a part of a contour of the subject under examination, one or more regions in the global 2D contour image possibly belonging to a part of the contour of the subject under examination; and filtering the one or more regions based on geometric information and position information to obtain the 2D contour image of the subject under examination.

In an embodiment, the method may further include determining whether at least a part of the subject under examination is capable of being detected in the global 3D contour image; and in response to determining that at least a part of the subject under examination is incapable of being detected, generating a corresponding imaging operation prompt.

In an embodiment, determining whether at least a part of the subject under examination is capable of being detected in the global 3D contour image includes determining whether one or more key points of the subject under examination are capable of being detected, wherein the one or more key points indicate one or more anatomical positions of the subject under examination.

In an embodiment, the imaging operation prompt includes visually presenting the potential collision pixel, or issuing a collision warning.

According to a second aspect of the present invention, an imaging device is provided. The imaging device is configured to visually examine a subject under examination. The imaging device includes a movable scanning table, configured to place a subject under examination; a camera, configured to obtain a global 3D contour image comprising the imaging device and a pre-identified object, wherein the pre-identified object comprises at least a part of the subject under examination; and a processing unit, wherein the processing unit is configured to be used to: obtain the global 3D contour image; predict a potential collision pixel at which the pre-identified object will possibly collide with the imaging device in a process of being moved; obtain a contour image of the subject under examination; determine whether the potential collision pixel falls within a range of the contour image of the subject under examination; and in response to the aforementioned determination, generate a corresponding imaging operation prompt.

In an embodiment, the pre-identified object further includes an accessory of the imaging device.

In an embodiment, the processing unit is further configured to be used to determine a scan range of interest from the global 3D contour image, wherein the scan range of interest comprises at least a region of interest of the subject under examination, wherein the potential collision pixel is predicted only for the scan range of interest in the global 3D contour image.

In an embodiment, the processing unit is configured to predict the potential collision pixel via the following operations: converting coordinates of the pre-identified object from a coordinate system of the camera to a coordinate system of the imaging device; and determining, based on coordinates of the pre-identified object after conversion and movement plan information of the subject under examination, whether the pre-identified object will overlap with a 3D contour of the imaging device in a process in which the pre-identified object is moved according to the movement plan information, wherein the 3D contour of the imaging device is obtained from the imaging device.

In an embodiment, the processing unit is further configured to be used to in response to determining that the potential collision pixel does not exist or the potential collision pixel does not fall within the range of a 2D contour image of the subject under examination, cause the imaging device to move the subject under examination based on the movement plan information.

In an embodiment, the processing unit is configured to determine, via the following operations, whether the potential collision pixel falls within the range of the contour image: extracting a 2D contour image of the subject under examination from the global 3D contour image; projecting the potential collision pixel onto the same 2D plane as the 2D contour image; and determining whether a projection of the potential collision pixel on the 2D plane falls within a range of the 2D contour image of the subject under examination.

In an embodiment, the processing unit is configured to extract the 2D contour image of the target subject under examination via the following operations: obtaining a global 2D contour image in the global 3D contour image; determining, based on a probability value that each pixel in the global 2D contour image belongs to a part of a contour of the subject under examination, one or more regions in the global 2D contour image possibly belonging to a part of the contour of the subject under examination; and filtering the one or more regions based on geometric information and position information to obtain the 2D contour image of the subject under examination.

In an embodiment, the processing unit is further configured to be used to determine whether at least a part of the subject under examination is capable of being detected in the global 3D contour image; and in response to determining that at least a part of the subject under examination is incapable of being detected, generate a corresponding imaging operation prompt.

In an embodiment, the processing unit is configured to determine, via the following operation, whether at least a part of the target subject under examination is capable of being detected in the 3D contour image of the subject under examination: determining whether one or more key points of the subject under examination are capable of being detected, wherein the one or more key points indicate one or more anatomical positions of the subject under examination.

In an embodiment, the imaging operation prompt includes visually presenting the potential collision pixel, or issuing a collision warning.

According to a third aspect of the present disclosure, a computer-readable storage medium having instructions stored thereon is provided. When the instructions are executed, a processor is caused to implement the method according to any one of the aforementioned embodiments.

### BRIEF DESCRIPTION OF THE DRAWINGS

The present invention can be better understood by means of the description of the exemplary embodiments of the present invention in conjunction with the drawings, in which:

FIG. 1 shows a schematic diagram of an exemplary CT imaging system 100;

FIG. 2 shows an exemplary imaging system 200 similar to the CT imaging system 100 in FIG. 1;

FIG. 3 shows a flowchart of an imaging method 300 having enhanced collision prediction according to a technique of the present disclosure;

FIG. 4 shows a schematic block diagram of a system 400 for calibration between a coordinate system of an RGB-D camera and a coordinate system of an imaging device according to a technique of the present disclosure;

FIG. 5 shows a schematic diagram of operations of a system 400;

FIG. 6 shows a schematic diagram of a calibration tool 410 in a system 400;

FIG. 7 shows a pixel position of each marker 415 on a calibration tool 410;

FIG. 8 shows a flowchart of step 320 of calibration between a coordinate system of an RGB-D camera and a coordinate system of an imaging device;

FIG. 9 is a flowchart showing step 340 of determining whether one or more key points of a subject under examination are capable of being detected from an image;

FIG. 10A to FIG. 10E show schematic diagrams of key points of a human subject under examination;

FIG. 11A and FIG. 11B show block diagrams of a deep learning model for extracting a feature from an image for segmentation according to a technique of the present disclosure;

FIG. 12 shows a block diagram of a deep learning model 1200 for segmenting an image to obtain an image mask according to a technique of the present disclosure;

FIG. 13A shows a schematic diagram of using a camera to acquire a 2D image of an object;

FIG. 13B schematically shows a corresponding geometric relationship between relevant parameters in FIG. 13A;

FIG. 14 illustrates an example block diagram of a computing device 1400 according to a technique of the present disclosure;

FIG. 15 shows a schematic diagram of a possible collision of a subject under examination in an examination process; and

FIG. 16 shows a schematic diagram of classification of potential collision sites.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific implementations of the present invention will be described below. It should be noted that in the specific description of said implementations, for the sake of brevity and conciseness, the present description cannot describe all of the features of the actual implementations in detail. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content disclosed in the present invention, some design, manufacture, or production changes made on the basis of the technical content disclosed in the present disclosure are only common technical means, and should not be construed as the content of the present disclosure being insufficient.

References in the specification to “an embodiment”, “embodiment”, “example embodiment”, and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless defined otherwise, technical terms or scientific terms used in the claims and description should have the usual meanings that are understood by those of ordinary skill in the technical field to which the present invention belongs. The terms “include” or “comprise” and similar words indicate that an element or an object preceding the terms “include” or “comprise” encompasses elements or objects and equivalent elements thereto listed after the terms “include” or “comprise”, and do not exclude other elements or objects.

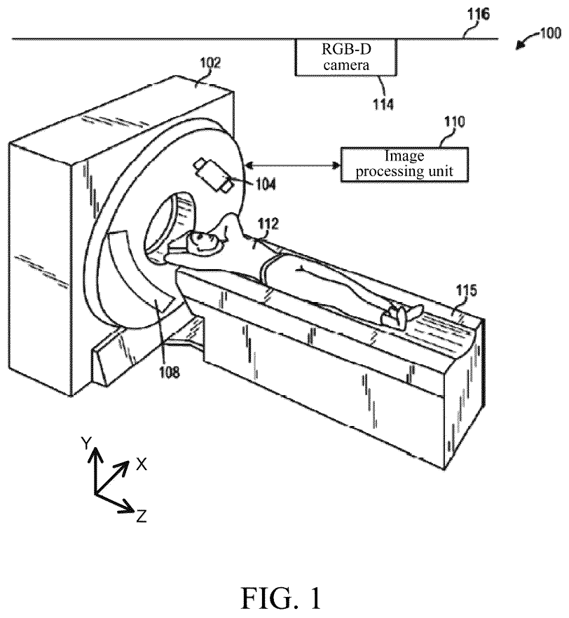

Implementations of the present disclosure will be described below by way of example with reference to FIG. 1 to FIG. 14. The following description relates to various examples of an imaging method and an imaging system. Specifically, the imaging method and an imaging device are provided.

Although a CT system is described by way of example, it should be understood that the techniques of the present disclosure are broadly applicable to various fields of non-destructive examination. The techniques of the present disclosure may also be useful when applied to images acquired by using other imaging modalities, such as an X-ray imaging system, a magnetic resonance imaging (MRI) system, a positron emission tomography (PET) imaging system, a single photon emission computed tomography (SPECT) imaging system, and combinations thereof (e.g., a multi-modal imaging system such as a PET/CT, PET/MR, or SPECT/CT imaging system). The discussion of the CT imaging system in the present disclosure is provided only as an example of one suitable imaging system.

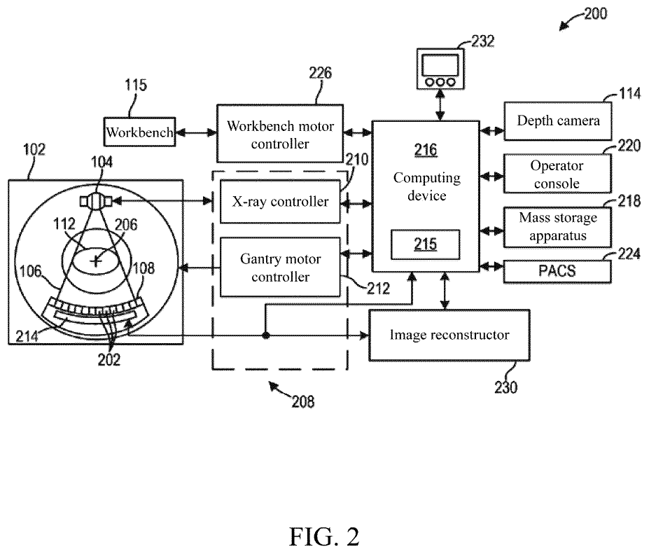

FIG. 1 shows a schematic diagram of an exemplary CT imaging system 100. Specifically, the CT imaging system (also referred to as a CT device) 100 is configured to image a subject 112 (such as a patient, an inanimate subject, one or more manufactured components, an industrial component, or a foreign subject). Throughout the present disclosure, the terms “subject”, “subject being scanned”, and “subject under examination” may be used interchangeably, and it should be understood that, at least in some embodiments, a patient is a type of subject that may be imaged by the CT imaging system 100, and that a subject may include a patient. In some implementations, the CT imaging system 100 includes a gantry 102, which may include at least one X-ray radiation source 104. The at least one X-ray radiation source 104 is configured to project an X-ray beam (or X-ray) 106 (see FIG. 2) for imaging the subject 112. Specifically, the X-ray radiation source 104 is configured to project the X-ray 106 toward a detector array 108 positioned on the opposite side of the gantry 102. Although FIG. 1 illustrates only one X-ray radiation source 104, in some implementations, a plurality of X-ray radiation sources 104 may be used to project a plurality of X-rays 106 toward a plurality of detectors, so as to acquire projection data corresponding to the subject 112 at different energy levels.

In some implementations, the X-ray radiation source 104 projects a fan-shaped or cone-shaped X-ray beam 106. The fan-shaped or cone-shaped X-ray beam 106 is collimated to be located in an X-Y plane of a Cartesian coordinate system, and the plane is generally referred to as an “imaging plane” or a “scanning plane”. The X-ray beam 106 passes through the subject 112. The X-ray beam 106, after being attenuated by the subject 112, is incident on the detector array 108. The intensity of the attenuated radiation beam received at the detector array 108 depends on the attenuation of the X-ray 106 by the subject 112. Each detector element of the detector array 108 produces a separate electrical signal that serves as a measure of the intensity of the beam at the detector position. Intensity measurements from all detectors are separately acquired to generate a transmission distribution.

In third-generation CT imaging systems, the gantry 102 is used to rotate the X-ray radiation source 104 and the detector array 108 within the imaging plane around the subject 112, so that the angle at which the X-ray beam 106 intersects with the subject 112 is constantly changing. A full gantry rotation occurs when the gantry 102 completes a full 360-degree rotation. A set of X-ray attenuation measurements (e.g., projection data) from the detector array 108 at one gantry angle is referred to as a “view”. Thus, the view represents each incremental position of the gantry 102. A “scan” of the subject 112 includes a set of views made at different gantry angles or viewing angles during one rotation of the X-ray radiation source 104 and the detector array 108.

In some examples, the CT imaging system 100 may include an RGB-D camera 114 positioned on or outside the gantry 102. As shown in FIG. 1, the RGB-D camera 114 is mounted on a ceiling panel 116 positioned above the subject 112 and oriented to image the subject when the subject 112 is at least partially outside the gantry 102. The RGB-D camera 114 may include one or more light sensors, including one or more visible light sensors and/or one or more infrared (IR) light sensors. In some implementations, the one or more IR sensors may include one or more sensors in a near-IR range and a far-IR range to implement thermal imaging. In some implementations, the RGB-D camera 114 may further include an IR light source. The light sensor may be any 3D depth sensor, such as a time-of-flight (ToF) sensor, a stereo sensor, or a structured light depth sensor, the 3D depth sensor being operable to generate a 3D depth image, while in other implementations, the light sensor may be a two-dimensional (2D) sensor operable to generate a 2D image. In some such implementations, a 2D light sensor may be used to infer a depth from knowledge of light reflection to estimate a 3D depth. Regardless of whether the light sensor is a 3D depth sensor or a 2D sensor, the RGB-D camera 114 may be configured to output a signal encoding an image to a suitable interface. The interface may be configured to receive, from the RGB-D camera 114, the signal encoding the image. A 3D point cloud of an object within the field of view of the RGB-D camera 114 may be generated based on the signal encoding the image, and a 3D point cloud of the subject 112 may be extracted from the 3D point cloud of the object.

The CT imaging system 100 further includes an image processing unit 110 configured to present an image of a patient, to render and present a scan range indicator on the image of the patient using the method described herein, and to reconstruct an image of a target volume of the patient using a suitable reconstruction method (such as an iterative or analytical image reconstruction method).

The CT imaging system 100 further includes a scanning table 115, and the subject 112 is positioned on the scanning table to facilitate imaging. The scanning table 115 may be electrically powered, so that a vertical position and/or a lateral position of the scanning table can be adjusted. Accordingly, the scanning table 115 may include a motor and a motor controller, as will be explained below with respect to FIG. 2. The scanning table motor controller moves the scanning table 115 by adjusting the motor, so as to properly position the subject in the gantry 102 to acquire projection data corresponding to the target volume of the subject. The scanning table motor controller may adjust the height of the scanning table 115 (e.g., a vertical position relative to a floor on which the scanning table is located) and a lateral position of the scanning table 115 (e.g., a horizontal position of the scanning table along an axis parallel to an axis of rotation of the gantry 102).

FIG. 2 shows an exemplary imaging system 200 similar to the CT imaging system 100 in FIG. 1. In some implementations, the imaging system 200 includes the detector array 108 (see FIG. 1). The detector array 108 further includes a plurality of detector elements 202, which together obtain the X-ray beam 106 (see FIG. 1) passing through the subject under examination 112 to obtain corresponding projection data.

In some implementations, the imaging system 200 includes a control mechanism 208 to control the movement of the components, such as the rotation of the gantry 102 and the operation of the X-ray radiation source 104. In some implementations, the control mechanism 208 further includes an X-ray controller 210, the X-ray controller 210 being configured to provide power and timing signals to the X-ray radiation source 104. Additionally, the control mechanism 208 includes a gantry motor controller 212, configured to control the rotational speed and/or position of the gantry 102 on the basis of imaging requirements.

In some implementations, the control mechanism 208 further includes a data acquisition system (DAS) 214, configured to sample analog data received from the detector elements 202, and convert the analog data to a digital signal for subsequent processing. The data sampled and digitized by the DAS 214 is transmitted to a computer or computing device 216. In an example, the computing device 216 stores data in a storage apparatus 218. For example, the storage apparatus 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In some implementations, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows only one operator console 220, more than one operator console may be coupled to the imaging system 200, for example, for inputting or outputting system parameters, requesting examination, and/or viewing images. Moreover, in some implementations, the imaging system 200 may be coupled to, for example, a plurality of displays, printers, workstations, and/or similar devices located locally or remotely within an institution or hospital or at a completely different location by means of one or more configurable wired and/or wireless networks (such as the Internet and/or a virtual private network).

In some implementations, for example, the imaging system 200 includes or is coupled to a picture archiving and communication system (PACS) 224. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-provided and/or system-defined commands and parameters to operate the scanning table motor controller 226, the scanning table motor controller being able to control the scanning table motor, thereby adjusting the position of the scanning table 115 shown in FIG. 1. Specifically, the scanning table motor controller 226 moves the scanning table 115 by means of the scanning table motor, so as to properly position the subject 112 in the gantry 102 to acquire projection data corresponding to a target volume of the subject 112. For example, the computing device 216 may send a command to the scanning table motor controller 226, so as to instruct the scanning table motor controller 226 to adjust the vertical position and/or the lateral position of the scanning table 115 by means of the motor.

In some implementations, the display 232 may allow the operator to select a volume of interest (VOI) and/or request subject information, for example, by means of a graphical user interface (GUI), for subsequent scanning or processing.

As described further herein, the computing device 216 may include computer-readable instructions executable to present a collision prediction result on the image of the subject under examination 112 on the basis of an RGB-D image of the subject under examination 112.

The RGB-D camera 114 may be operably and/or communicatively coupled to the computing device 216 to provide image data to determine the anatomy of the subject, including posture and orientation. Additionally, various methods and processes described further herein for presenting a boundary of the scan range in the image of the patient on the basis of the depth image data generated by the RGB-D camera 114 may be stored as executable instructions in a non-transitory memory of the computing device 216.

Additionally, in some examples, the computing device 216 may include a camera image data processor 215 that includes instructions for processing information received from the RGB-D camera 114. The information (which may include depth information and/or visible light information) received from the RGB-D camera 114 may be processed to determine various parameters of the subject, such as the identity of the subject, the physique of the subject (e.g., height, weight, and patient thickness), and the current position of the subject relative to the scanning table and the RGB-D camera 114. For example, prior to imaging, the body contour or anatomy of the subject 112 may be estimated using images reconstructed from point cloud data, the point cloud data being generated by the camera image data processor 215 according to depth images received from the RGB-D camera 114. The computing device 216 may use these parameters of the subject to perform, for example, patient-scanner contact prediction, scan range superposition, and scan key point calibration, as will be described in further detail herein. Further, data from the RGB-D camera 114 may be displayed by means of the display 232.

The CT imaging system 100 may perform imaging examination on the basis of a scanning protocol. The scanning protocol is a description of the imaging examination. The scanning protocol may include a description of an involved body part, for example, a medical or colloquial term for the body part. The scanning protocol may provide various parameters and related information for performing scans and post-processing, such as a power value, duration of radiation, speed of movement, radiation energy, time delay between image captures, etc. It is conceivable that any configurable technical parameter that should be used for imaging examination by the imaging system 110 may be defined in the scanning protocol.

The CT imaging system 100 may have an automatic patient positioning function. That is, a patient may be automatically positioned in a scan start position in an opening of the gantry 102 on the basis of an examination instruction or the scanning protocol, and moved to a scan end position during scanning and imaging in the scanning direction (e.g., a Z-axis direction in the coordinate system shown in FIG. 1, namely, a direction in which the scanning table 115 and the subject 112 carried on the scanning table enter or exit the opening of the gantry 102). The scan start position and the scan end position may be visually presented using the methods described in the present disclosure, and change as the operator adjusts the scan range indicator.

Before CT imaging is performed on the subject 112, it may be predicted whether the gantry 102 will collide with any object during movement of the scanning table 115. However, such a collision may be caused by the following: (1) a body part of the subject 112, e.g., an elbow joint, a leg, or the head; (2) various accessories, e.g., a sheet on the scanning table 115, a tube attached to the subject 112, and a blanket; and (3) noise, e.g., caused by an operator too close to the subject. In the case of a collision caused by the body part of the subject 112, the collision may injure the subject 112. Therefore, an adjustment needs to be performed before the scanning table 115 starts to be moved. However, even if the accessories on the scanning table are subjected to a collision, the scanning is not affected, and the subject 112 is not injured. The operator does not enter a scanner gantry bore together with the scanning table 115, and therefore does not actually collide with the scanner gantry.

In view of this, the present disclosure provides a method for predicting a collision, and by predicting the collision and determining whether an adjustment needs to be performed to avoid such a collision, a safer and smoother working procedure can be provided, improving working efficiency and preventing collision hazards.

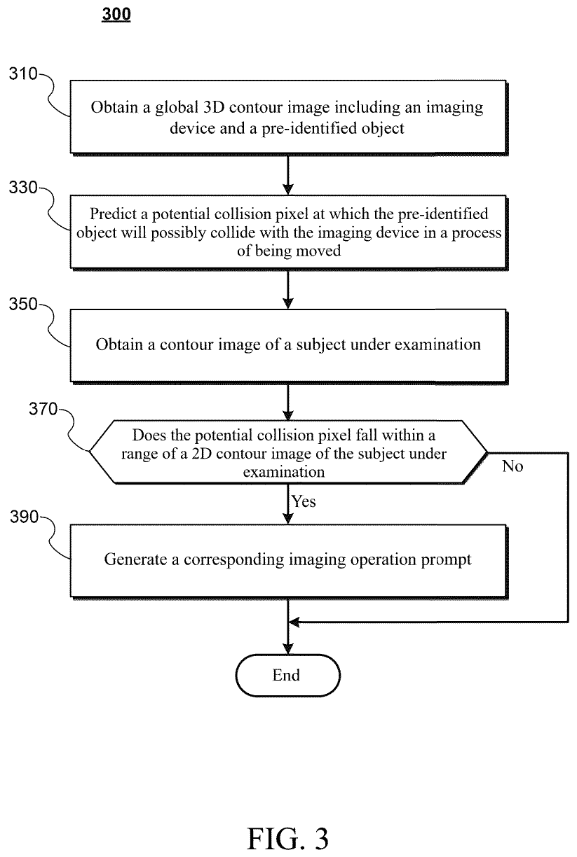

FIG. 3 shows a flowchart of an imaging method 300 having enhanced collision prediction according to a technique of the present disclosure.

The method 300 starts at step 310. In step 310, a global 3D contour image including an imaging device (a CT device) 200 and a pre-identified object is obtained. Optionally, a 3D contour image of the imaging device 200 may be data obtained from the imaging device 200. The pre-identified object may include a scanning region of interest for imaging, which may include at least a part of a subject under examination (e.g., a region of interest of the subject under examination) and regions within a certain range around the at least a part of the subject under examination. When the subject under examination is the subject 112, the region of interest of the subject under examination may be a region to be examined of the subject 112. Therefore, various accessories as described above may also be included within the scanning region of interest. For example, the scanning region of interest may be calculated by the computing device 216 via an algorithm and/or computer-readable instructions based on a command and/or a parameter provided by the operator via the operator console 220, or may be set by the operator via the operator console 220. Optionally, a 3D contour image of the pre-identified object may be an image generated by the RGB-D camera 114.

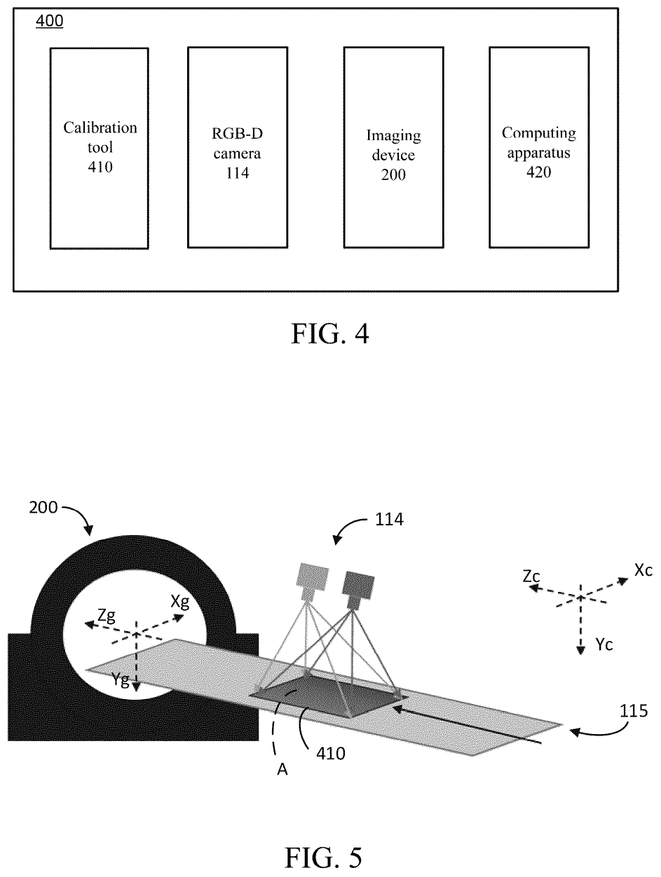

When the 3D contour image of the imaging device 200 is obtained from the imaging device 200 and the 3D contour image of the pre-identified object is generated by the RGB-D camera 114, the method 300 may additionally include step 320 of calibration between a coordinate system of the RGB-D camera and a coordinate system of the imaging device. FIG. 4 shows a schematic block diagram of a system 400 for calibration between the coordinate system of the RGB-D camera and the coordinate system of the imaging device according to a technique of the present disclosure. The system 400 includes a calibration tool 410, the RGB-D camera 114, the imaging device 200, and a computing apparatus 420. FIG. 5 shows a schematic diagram of operations of the system 400. Xc, Yc, and Ze represent the coordinate system of the RGB-D camera 114, and Xg, Yg, and Zg represent the coordinate system of the imaging device 200.

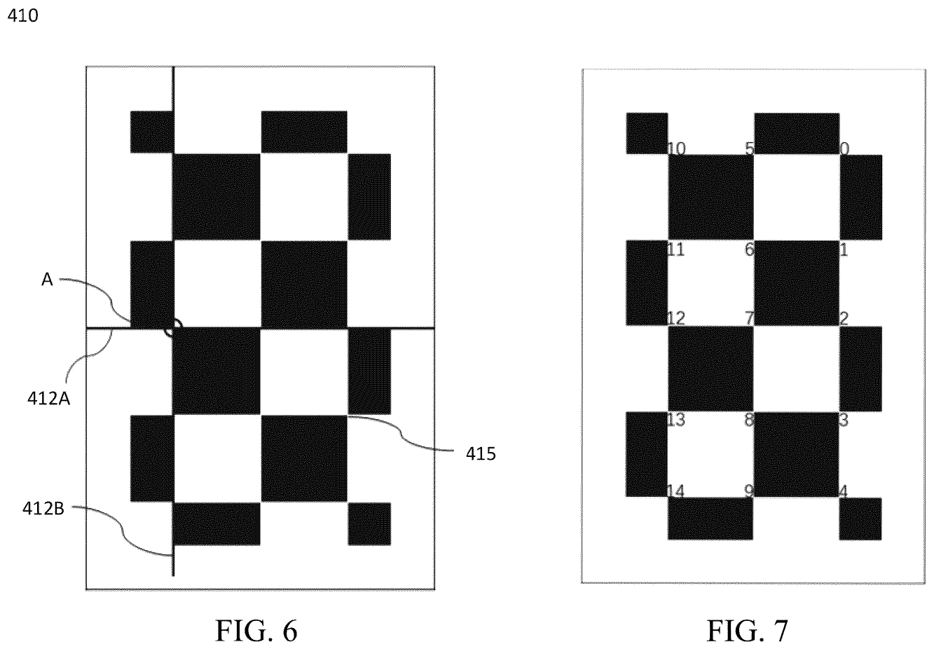

It can be learned with reference to FIG. 5 that the calibration tool 410 is provided on the scanning table in the medical imaging device. It can be learned with reference to FIG. 6 that markers 415 and a reference point A are provided on the calibration tool 410. The reference point A is aligned with a center of the imaging device 200 to serve as an origin (0, 0, 0) (namely, an intersection of Xg, Yg, and Zg axes) of the coordinate system of the imaging device. Then positions of the markers 415 in the coordinate system of the imaging device are calculated based on relative positions of the markers 415 with respect to the reference point A (namely, the origin of the coordinate system of the medical imaging device).

The RGB-D camera 114 shown in FIG. 4 and FIG. 5 is configured to capture images of the markers 415 and determine positions of the markers 415 in the coordinate system of the RGB-D camera based on the captured images.

The computing apparatus 420 shown in FIG. 4 performs the following calculation function on the basis of the above-mentioned two sets of position data: using the positions of the markers 415 in the coordinate system of the RGB-D camera as a first data set, using the positions of the markers 415 in the coordinate system of the imaging device as a second data set, based on the first data set and the second data set, calculating a calibration matrix M between the coordinate system of the RGB-D camera and the coordinate system of the imaging device, and performing calibration between the coordinate system of the RGB-D camera and the coordinate system of the medical imaging device using the calibration matrix M.

The above-mentioned system does not require imaging scanning at all in the process of calculating the calibration matrix. Positions of the markers 415 on the calibration tool 120 in the coordinate system of the imaging device can be obtained through the computing apparatus 160 through pure calculation. Together with the positions of the markers 415 in the coordinate system of the RGB-D camera 114 which are obtained through the RGB-D camera, the calibration matrix M between the coordinate system of the RGB-D camera and the coordinate system of the imaging device can be obtained based on the two sets of position data. The entire process does not need to be subjected to any radiation, achieving very high radiation safety. Time is also saved because no imaging scanning is required, and the operator does not need to leave the scanning room to control imaging scanning on the operator console. In addition, based on the relative positions of the markers 125 with respect to the reference point A, the positions of the markers 415 in the coordinate system of the imaging device are calculated, which also significantly improves the accuracy of calibration between the coordinate systems of the RGB-D camera 114 and the medical imaging device.

Furthermore, laser beams emitted by a laser lamp in the imaging device intersect with the reference point A at the center of the imaging device.

FIG. 6 shows a schematic diagram of the calibration tool 410 in the above-mentioned system, which is specifically represented in the form of pixels of alternate black and white squares.

As shown in FIG. 6, the calibration tool 410 is further provided with auxiliary lines 412A and 412B intersecting at the reference point A. The auxiliary lines 412A and 412B may preferably be perpendicular to each other on the plane on which the calibration tool 120 is located as shown in FIG. 6, namely, in the directions of the Xg axis and the Zg axis shown in FIG. 5, respectively. The laser beams emitted by the laser lamp may include a first beam and a second beam. The calibration tool 410 may be moved so that the auxiliary lines 412A and 412B coincide with the first beam and the second beam, respectively, and thus the reference point A can be aligned with the center of the medical imaging device more conveniently.

In this way, the reference point A is intuitively and easily determined as the origin (0, 0, 0) of the coordinate system of the imaging device. FIG. 6 further shows the positions of the markers 415. In the figure, an intersection of each black square and each white square corresponds to one marker 415.

Although it is described above that the reference point A is aligned with the center of the medical imaging device via the auxiliary lines 412A and 412B, it should be clear to those skilled in the art that the reference point A can be aligned with the center of the medical imaging device even without the auxiliary lines 412A and 412B.

Further refer to FIG. 7, which shows a pixel position of each marker 415 on the calibration tool 410. The pixel position is a pixel position of the marker 415 in the coordinate system of the RGB-D camera.

An intersection of each black square and each white square in FIG. 7 corresponds to one marker 415. The number labeled next to the marker is a relative distance from the marker to the reference point A, and a coordinate position of each marker 415 in the coordinate system of the imaging device can be obtained based on the relative distance.

In view of the above, the system 400 for calibration between the coordinate system of the RGB-D camera and the coordinate system of the imaging device performs benchmarking with the calibration tool 410 by means of the laser lamp. Compared with the conventional method for obtaining the position of a calibration tool using imaging scanning, the calibration tool may be positioned more intuitively, having higher radiation safety, and saving time as the operator does not have to control imaging scanning outside the scanning room.

The auxiliary lines 412A and 412B are further introduced as shown in FIG. 6, so as to facilitate faster alignment of the reference point A on the calibration tool 410 with the center of the imaging device.

It should be particularly noted that although 14 markers 415 on the calibration tool 410 in FIG. 6 and FIG. 7 are shown, the number of markers 415 may be set to any number according to needs in practice, for example, 30. Moreover, although the markers 415 in FIG. 6 and FIG. 7 are rectangular, the sizes and shapes of the markers 415 may alternatively be set according to needs in practice. The markers 415 may have various shapes, and the shapes of the markers 415 may be designed to be accurately captured by the RGB-D camera 114 more casily so as to generate marker positions of the markers 415 in the coordinate system of the RGB-D camera. Once the shapes and sizes of the markers 415 are set according to needs, when calculating the positions of the markers 415 in the coordinate system of the imaging device, the set shapes and sizes may also be considered in addition to the relative positions of the markers 415 with respect to the reference point A.

In view of this, the markers 415 provided on the calibration tool 410 may have various shapes, which brings great convenience to a user and facilitates updating. The operator only needs to enter the positions, shapes, and sizes of the markers 415, and the calibration can be implemented automatically.

In addition, in the above-mentioned calibration system 400, the RGB-D camera 114 captures depth images, infrared images, and RGB images of the markers 415, and may process the infrared images and the RGB images using, for example, an open-source method in a cross-platform computer vision library (OpenCV), so as to obtain pixel positions of the markers 415 in the coordinate system of the RGB-D camera, as shown in FIG. 7.

Furthermore, depth information of the markers 415 may be obtained from the depth images of the markers 415. Thus, based on the depth information and the previously obtained pixel positions of the markers 415 in the coordinate system of the RGB-D camera, a three-dimensional position (Xc, Yc, Zc) of each marker 415 in the coordinate system of the RGB-D camera can be determined.

In the system 400 for calibration between the coordinate system of the RGB-D camera and the coordinate system of the imaging device according to the present invention, the calibration matrix M first includes a rotation matrix r and a translation matrix t. The two matrices already can implement calibration between the coordinate system of the RGB-D camera and the coordinate system of the imaging device. However, since the size of an object obtained in the RGB-D camera 114 may be different from the physical size of the object in the real world, according to the present invention, the calibration matrix M further particularly includes a scaling matrix s, so as to exclude an object of which the size is inaccurate compared with the real physical size. In this way, the calibration matrix M is undoubtedly enhanced, and better calibration accuracy can be obtained.

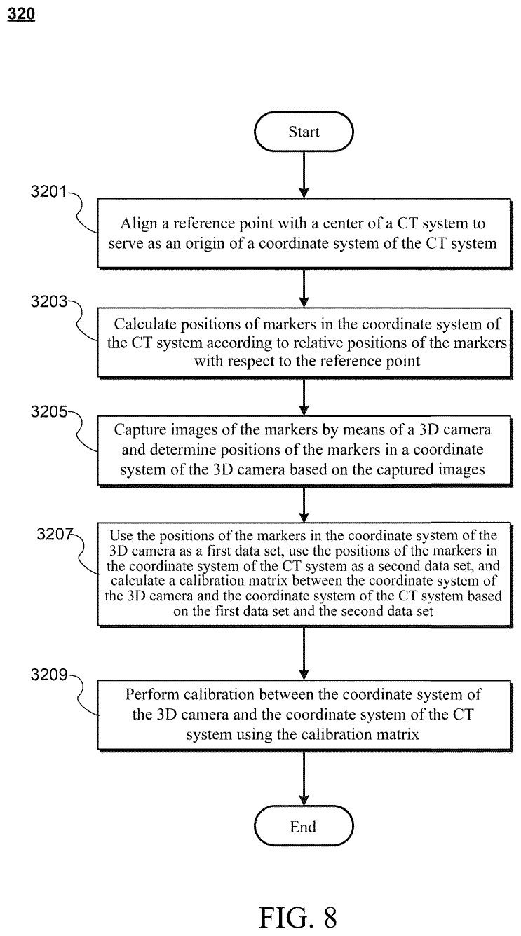

FIG. 8 shows a flowchart of step 320 of calibration between the coordinate system of the RGB-D camera and the coordinate system of the imaging device as described above, including sub-step 3201 to sub-step 3209. With reference to FIG. 5 again, the calibration tool 410 is provided on the scanning table 115 in the imaging device 200, and the calibration tool 410 is provided with the reference point A and the markers 415.

Referring to FIG. 8, in step 3201, the reference point A is aligned with the center of the imaging device 200 to serve as the origin of the coordinate system of the imaging device.

For example, the laser beams emitted by the laser lamp in the imaging device 200 may be made intersect with the reference point A at the center of the imaging device 200. In this way, in the above-mentioned step 3201, the reference point A is aligned with the center of the imaging device 200.

With further reference to FIG. 6, the auxiliary lines 412A and 412B intersecting at the reference point A may be further provided on the calibration tool 120, for example. The laser beams emitted by the laser lamp may include the first beam and the second beam. The calibration tool 120 may be moved so that the auxiliary lines 412A and 412B coincide with the first beam and the second beam respectively, and thus the reference point A can be aligned with the center of the imaging device 200 more conveniently.

Referring back to FIG. 8, in step 3203, the positions of the markers 415 in the coordinate system of the imaging device are calculated based on the relative positions of the markers 415 with respect to the reference point A.

As shown in FIG. 7, an intersection of each black square and each white square corresponds to one marker 415, the number labeled next to the marker is a relative distance from the marker to the reference point A, and a coordinate position of each marker 415 in the coordinate system of the medical imaging device can be obtained based on the relative distance.

In addition, in step 3203, the shapes and sizes of the markers 415 can be set. Moreover, once the shapes and sizes of the markers 415 are set, the positions of the markers 415 in the coordinate system of the medical imaging device are calculated based on the relative positions of the markers 415 with respect to the reference point A and the set shapes and sizes.

Still referring back to FIG. 8, in step 3205, images of the markers 415 are captured by means of the RGB-D camera 114 shown in FIG. 5, and the positions of the markers 415 in the coordinate system of the RGB-D camera are determined based on the captured images.

Specifically, the RGB-D camera 114 captures depth images, infrared images, and RGB images of the markers 415, and may process the infrared images and the RGB images of the markers 415 using the open-source method in OpenCV, so as to obtain the pixel positions of the markers 415 in the coordinate system of the RGB-D camera, as shown in FIG. 7.

The depth images of the markers 415 may be further processed to obtain depth information of the markers 415. The depth information corresponds to the pixel positions of the markers 415 in the coordinate system of the 3D camera. Thus, based on the depth information and the pixel positions of the markers 415 in the coordinate system of the 3D camera, three-dimensional positions (Xc, Yc, Zc) of the markers 415 in the coordinate system of the 3D camera can be determined.

It should be noted that although step 3205 is described by using the open-source method in OpenCV as an example, those skilled in the art should know that this step may alternatively be implemented using other image processing techniques, and is not limited to the open-source method in OpenCV.

Referring back to FIG. 8, in step 3207, the positions of the markers 415 in the coordinate system of the RGB-D camera are used as the first data set, the positions of the markers 415 in the coordinate system of the imaging device are used as the second data set, and based on the first data set and the second data set, the calibration matrix M between the coordinate system of the RGB-D camera and the coordinate system of the imaging device is calculated.

With reference to FIG. 5, as the scanning table moves in the Zg and Yg directions, when the calibration tool 410 enters the field of view (FOV) of the RGB-D camera 114, based on RGB images and infrared images, the pixel positions of the markers 415 on the calibration tool 410 are determined, and based on the pixel positions together with depth information obtained from depth images, coordinates of the markers 415 in the coordinate system of the RGB-D camera may be determined, so as to serve as the first data set. Based on the movement of the scanning table and the relative positions of the markers 415 with respect to the reference point A, the positions of the markers 415 in the coordinate system of the medical imaging device may be determined, so as to serve as the second data set.

According to the present invention, the calibration matrix M may specifically include the rotation matrix r, the translation matrix t, and the scaling matrix s. As previously described, the introduction of the scaling matrix s can exclude an object of which the size is incorrect compared with the real physical size.

Referring back to FIG. 8 again, finally, in step 3209, calibration between the coordinate system of the RGB-D camera and the coordinate system of the imaging device is implemented using the calibration matrix M.

Referring back to FIG. 3, in step 330, a potential collision pixel at which the pre-identified object will possibly collide with the imaging device in a process of being moved is predicted. Since 3D coordinate values of the imaging device are known, for example, if the imaging device is a CT scanner, 3D coordinate values of a gantry bore thereof may be directly obtained from a CT scanning system, and a path of movement of the pre-identified object may also be directly obtained from the imaging device. Therefore, based on a 3D contour of the pre-identified object and the 3D coordinate values of the gantry bore and the path of movement of the pre-identified object, it can be determined whether the pre-identified object will collide with the gantry bore in the process of being moved, that is, whether the 3D contour of the pre-identified object will overlap with a 3D contour of the gantry bore of the CT scanner.

Optionally, in step 330, it is predicted that there is no potential collision pixel at which the pre-identified object will possibly collide with the imaging device in the process of being moved, that is, a corresponding movement may be directly performed when the pre-identified object will not collide with the imaging device.

Preferably, the method 300 may include step 340 of determining whether one or more key points of the subject under examination are capable of being detected from an image. The image may be the global 3D contour image or an image of the scan range of interest as described above.

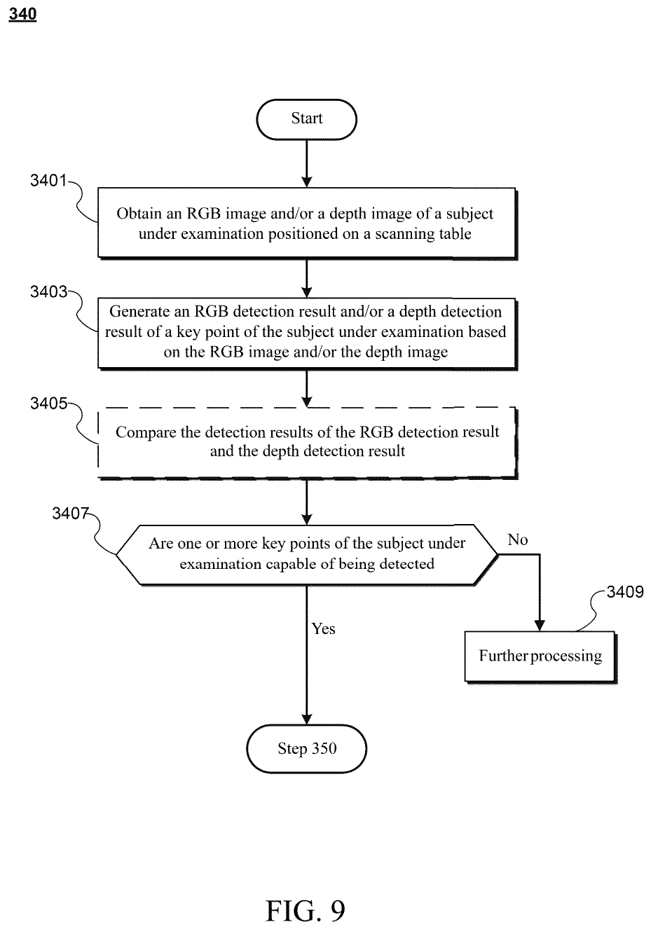

FIG. 9 is a flowchart showing step 340 of determining whether the one or more key points of the subject under examination are capable of being detected from the image as described above. Whether the one or more key points of the subject under examination are capable of being detected from the image may be determined based on an image obtained by the aforementioned RGB-D camera 114, and may be determined based on either or both of an RGB image and a depth image. Further, preferably, step 340 may be a deep learning-based step. In a preferred embodiment, step 340 may include sub-step 3401 to sub-step 3409.

First, in sub-step 3401, an RGB image detection model may receive an acquired RGB image and/or a depth image detection model may receive an acquired depth image. After the RGB image detection model receives the RGB image and/or the depth image detection model receives the depth image, optionally, the image may be pre-processed. The pre-processing may include, but is not limited to, changing the size of the image, smoothing the image, cutting the image, denoising the image, and so on.

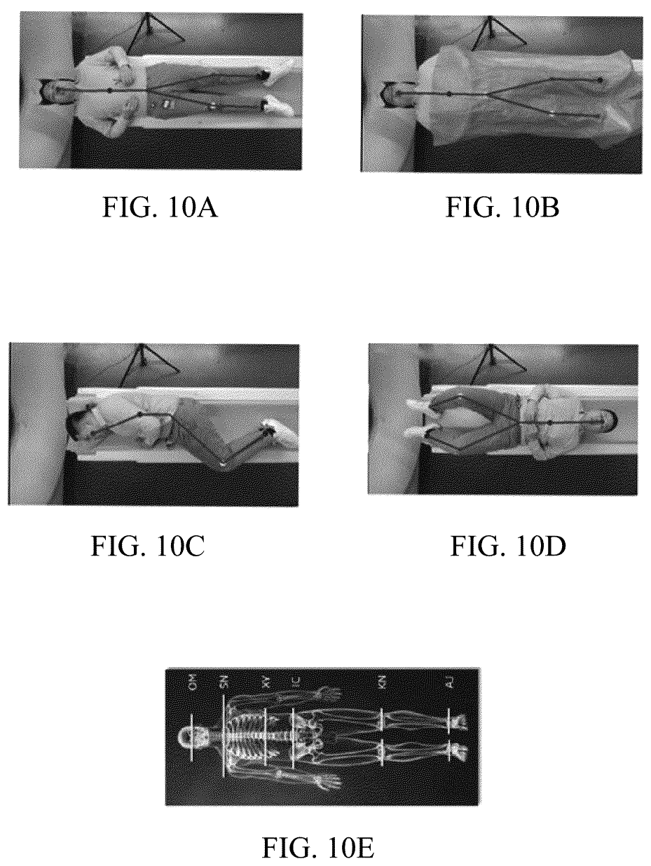

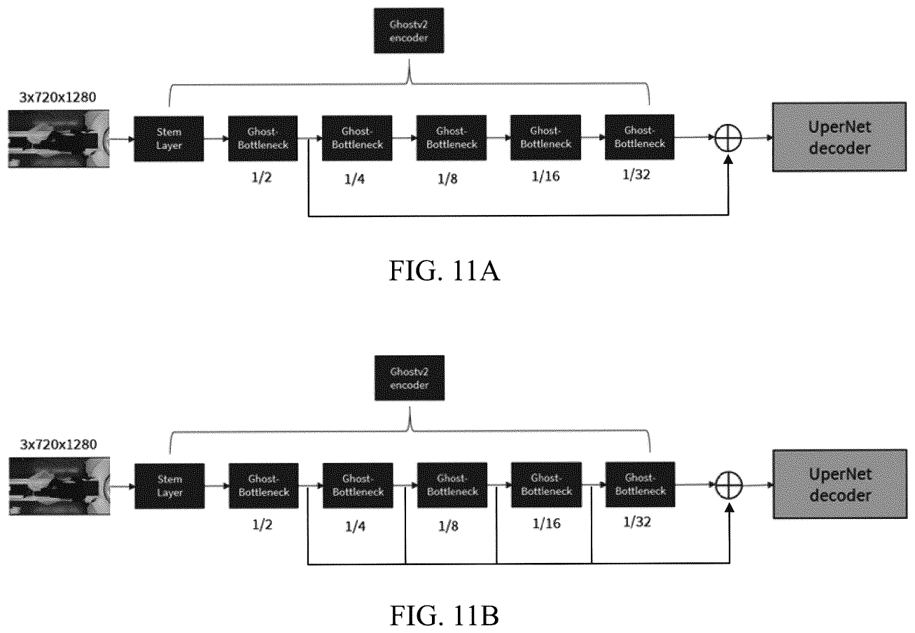

Next, in sub-step 3403, the RGB image detection model may generate an RGB image-based RGB detection result with respect to a predetermined key point of the subject under examination and/or the depth image detection model may generate a depth image-based depth detection result with respect to a predetermined key point of the subject under examination. In an embodiment, the RGB image detection model is utilized to identify the predetermined key point on the RGB image to generate the RGB detection result with respect to the key point of the subject under examination and/or the depth image detection model is utilized to identify the predetermined key point on the depth image to generate the depth detection result with respect to the key point of the subject under examination. The definition of a key point may depend on the clinical requirements. In the embodiment, a key point may be defined as commonly used important feature points, such as joints, the face, and so on. For living organisms, different key points correspond to different anatomical structure protocols. In the embodiment, the particular position of a key point may be specified at a position corresponding to a mark aimed at when carrying out a conventional laser scan for that particular site. The number of key points can be any suitable number depending on the clinical requirements. FIG. 10A to FIG. 10E show schematic diagrams of key points of a human subject under examination. In an exemplary embodiment of a human patient shown in FIG. 10E, there are eight key points, which are the head OM, chest SN, abdomen XY, pelvis IC, left knee joint and right knee joint KN, and left ankle joint and right ankle joint AJ, respectively. In other embodiments, there may be different numbers of key points, such as 18, or the key points may also be located elsewhere.

In step 3403, detecting, positioning, and thereby identifying key points to be detected requires the consideration of a number of additional factors, e.g., the scanning environmental conditions and postures of the subject to be scanned. In an embodiment, the factors that may be considered are whether the head or the feet first enter the gantry bore; whether the subject is supine, prone, lying on the left side, or lying on the right side; whether there is a covering, e.g., a blanket or a hospital gown; whether an extender is used, e.g., a head support; etc. FIG. 10A schematically shows the above-mentioned exemplary key points under the conditions of the head being first, the subject being supine, not having a covering, and using a head support. FIG. 10B schematically shows the above-mentioned exemplary key points under the conditions of the head being first, the subject being supine, having a covering, and using a head support. FIG. 10C schematically shows the above-mentioned exemplary key points under the conditions of the head being first, lying on the right side, not having a covering, and not using an extender. FIG. 10D schematically shows the above-mentioned exemplary key points under the conditions of the feet being first, being supine, not having a covering, and not using an extender.

With respect to the same key point of the same subject, based on an RGB image, an RGB branch outputs an RGB detection result, and based on a depth image, a depth branch outputs a depth detection result. The RGB branch and the depth branch may be independent of each other, and correspondingly, the generated RGB detection result and depth detection result may also be independent of each other. The RGB branch and the depth branch may be combined with each other, and correspondingly, the generated RGB detection result and depth detection result may also be combined with each other.

With continued reference to FIG. 1, next, in optional sub-step 3405, the detection results of the RGB detection result and the depth detection result may be compared. In an embodiment, the RGB detection result and the depth detection result may be compared with respect to one or more factors. Examples of such factors are as follows: a confidence level, a predetermined weight, the maximum peak of a heat map, the weighted average of all peaks of the heat map, a dispersion degree of peaks of the heat map, and so on. Through such comparison, the detection result that is more reliable among the detection results outputted by the two branches can be identified.

Then, in sub-step 3407, it is determined whether one or more key points of the subject under examination are capable of being detected.

If enough key points of the subject under examination are incapable of being detected in sub-step 3407, further processing may be performed in sub-step 3409. For example, the potential collision pixel predicted in the aforementioned step 330 may be presented to the operator, e.g., to take a manual action.

If enough key points of the subject under examination are capable of being detected in sub-step 3407, the method 300 may continue to be performed.

Referring back to FIG. 3, in step 350, a contour image of the subject under examination is obtained. Preferably, via a deep learning model, a 2D contour image of the subject under examination may be extracted from the previously obtained 3D contour image of the pre-identified object or the previously obtained global 3D contour image. FIG. 11A and FIG. 11B show block diagrams of the deep learning model for extracting a feature from an image for segmentation according to a technique of the present disclosure. An original image may be a 2D image that corresponds to a depth and that is extracted from the 3D contour image of the pre-identified object. Then, as shown in FIG. 11A, a Ghostnet v2 algorithm may be used as a backbone network, a shallow feature may be extracted from a 2D image subjected to a ghost bottleneck algorithm once, and the shallow feature may be combined with a deep feature of a 2D image subjected to the ghost bottleneck algorithm several times for a decoder (UperNet decoder) to segment the 2D image. Preferably, as shown in FIG. 11B, a shallow feature may be extracted from the 2D image subjected to the ghost bottleneck algorithm once, a feature may be extracted each time the 2D image is subjected to the ghost bottleneck algorithm, and the extracted features may be combined for use in segmenting the image. Preferably, a feature is extracted from an image each time the image is subjected to the ghost bottleneck algorithm, so that more information can be provided with a smaller number of channels, thereby speeding up the processing. In addition, preferably, the subsequent UperNet decoder performs decoding, so that a more complete image mask can be obtained.

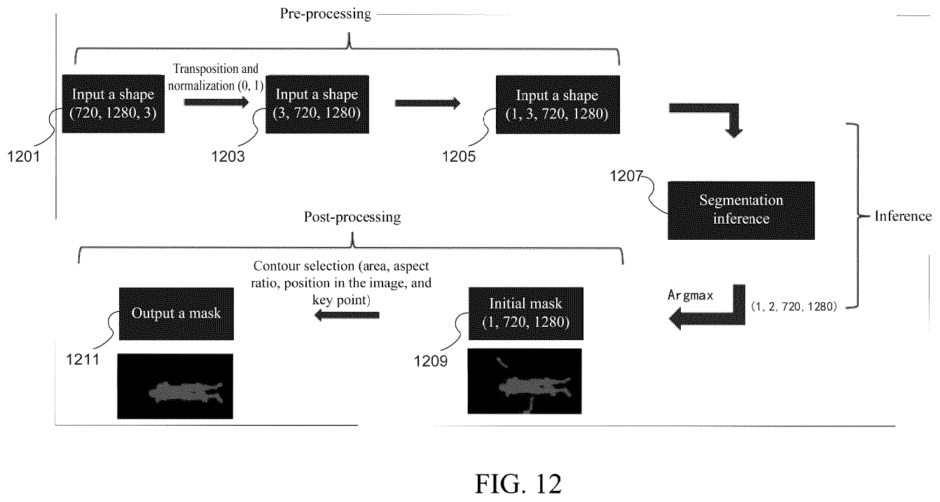

FIG. 12 shows a block diagram of a deep learning model 1200 for segmenting an image to obtain an image mask according to a technique of the present disclosure. The deep learning model may include a pre-processing stage (block 1201, block 1203, and block 1205), an inference stage (block 1207), and a post-processing stage (block 1209 and block 1211). Herein, an image of three channels×720 pixels×1280 pixels is used as an example for description. It should be understood that the deep learning model 1200 described herein may be used to process images of various channels and numbers of pixels. In the pre-processing stage, at block 1201, an original RGB image (720, 1280, 3) is obtained. For example, the original RGB image may be an image obtained by the RGB-D camera 114 and subjected to coordinate conversion as described above, that is, a 2D image that corresponds to a depth and that is extracted from the 3D contour image of the pre-identified object. Then, through transposition and normalization, at block 1203, a normalized image (3, 720, 1280) is obtained. “3” represents that three channels “R”, “G”, and “B” are included. At block 1205, an operator is appended to obtain (1, 3, 720, 1280). “1” represents that one operation is performed as one batch. Then, a matrix at block 1205 is inputted to the model described above with reference to FIG. 11a and FIG. 11b to obtain a matrix (1, 2, 720, 1280) of probability distributions for each pixel in the image. “2” represents that each pixel may have two dimensional value assignment probabilities. For example, an assigned value “0” may be used to represent a background part, and an assigned value “1” may be used to represent a foreground part. For each pixel, there is an irregular value to represent a probability value that the pixel should be classified as the background part “0” or the foreground part “1” in the figure. Then, at block 1209, via an Argmax operation and based on the probability value of each pixel, the background part and the foreground part of the image are separated to obtain (1, 720, 1280). For example, as schematically shown in FIG. 12, the foreground part represented in blue and the background part represented in black may be obtained. Preferably, a candidate region within the image may be further selected for denoising via some additional determination conditions to obtain an image mask at block 1211, that is, the 2D contour image of the subject under examination. The additional determination conditions for contour selection may include, for example, a region area, an aspect ratio, the position in the image, and a key point. It should be understood that the block diagram of the deep learning model 1200 shown in FIG. 12 is merely a preferred embodiment, and that those skilled in the art can implement the deep learning model 1200 without performing one or more types of processing therein.

Referring back to FIG. 3, in step 370, it is determined whether the potential collision pixel falls within a range of the contour image of the subject under examination. Herein, the potential collision pixel obtained in step 330 may be projected onto a 2D plane and compared with a 2D contour image of the subject under examination corresponding to the depth of the 2D plane. The 2D contour image of the subject under examination at the corresponding depth may be obtained via the deep learning model 1200. If, at this depth, the potential collision pixel is located within the 2D contour image of the subject under examination, it is determined that the potential collision pixel falls within the range of the contour image of the subject under monitoring.

Optionally, a 2D contour image of the subject under examination at each depth may be converted into a 3D contour of the subject under examination, and it may be determined whether the potential collision pixel falls within a range of the 3D contour of the subject under examination. Based on depth information in the RGB-D image and pixel distance information in the 2D contour, 3D coordinate values of each point on the subject under examination are calculated, and based on all the 3D coordinate values, the 3D contour is obtained.

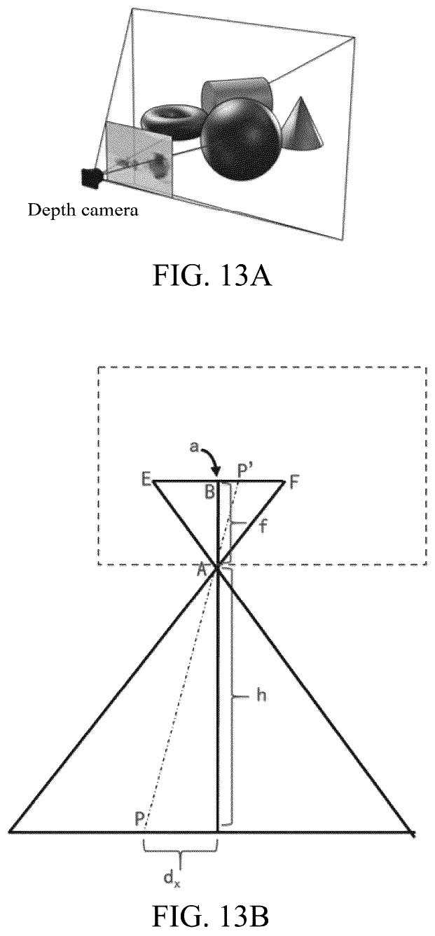

FIG. 13A shows a schematic diagram of using a camera to acquire a 2D image of an object. To obtain a 3D contour of the object, it is necessary to know 3D coordinate values of each point on the object, that is, the 3D coordinate values (x, y, z) of each point in FIG. 13A with respect to a center of the camera (that is, a focal point of the camera). FIG. 13B schematically shows a corresponding geometric relationship between relevant parameters in FIG. 13A. In FIG. 13B, a straight line a corresponds to the focal point of the camera, and the length of a line segment AB corresponds to a focal length f of the camera, which are inherent to the camera and are known. For a point P in FIG. 13B, depth information thereof in a depth image corresponds to a vertical depth h of the point P with respect to the focal point of the camera, that is, z in the abovementioned 3D coordinate values. x and y in the 3D coordinate values are vertical distances dx and dy from the point P to the focal point of the camera in the other two directions (that is, an X direction and a Y direction perpendicular to an X-Z plane in the figure). A line segment EF in FIG. 13B corresponds to a 2D image (2D contour) of the object, and P′ on EF may reflect 2D pixel distance information of the point P, including a pixel distance (BP′) from the point P′ to the focal point of the camera in the X direction and a pixel distance (not shown in FIG. 13B) from the point P′ to the focal point of the camera in the Y direction. It can be learned from the geometric relationship in the figure that f/h=BP′/dx, whereby dx, that is, x in the 3D coordinate values, can be calculated. It may be understood that FIG. 13B is only a schematic diagram of the X-Z plane for clarity of illustration, and similarly, in a schematic diagram of a Y-Z plane, dy, that is, y in the 3D coordinate values, can be calculated in the same way.

Thus, the 2D contour of the subject under examination can be converted into a 3D coordinate system, to obtain the 3D contour of the subject under examination and to determine whether the potential collision pixel falls within the 3D contour of the subject under examination.

Next, in response to determining in step 370 that the collision pixel falls within the range of the 2D contour image of the subject under examination, step 390 of generating a corresponding imaging operation prompt is performed. For example, the potential collision pixel may be visually presented. For example, the position of the potential collision pixel within the subject under examination may be displayed on the display to prompt an operation of adjusting the position or the like. Alternatively, a collision warning may be issued.

If it is determined in step 370 that the collision pixel does not fall within the range of the 2D contour image of the subject under examination, the operator may be prompted to perform examination.

It should be understood that those skilled in the art can contemplate various prompts or operations when a collision may or may not occur.

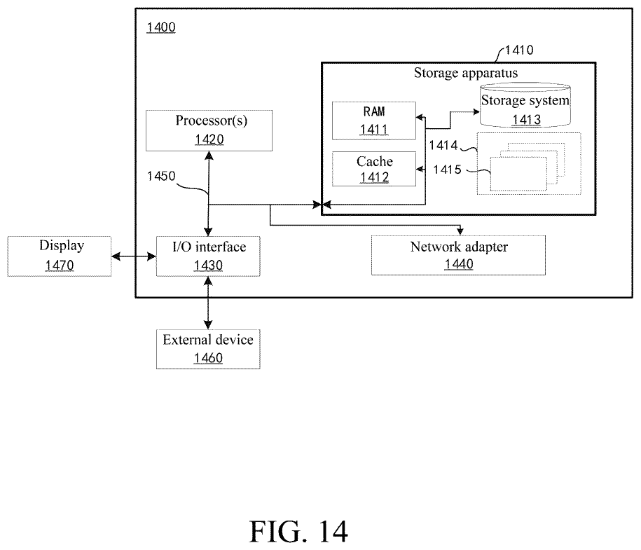

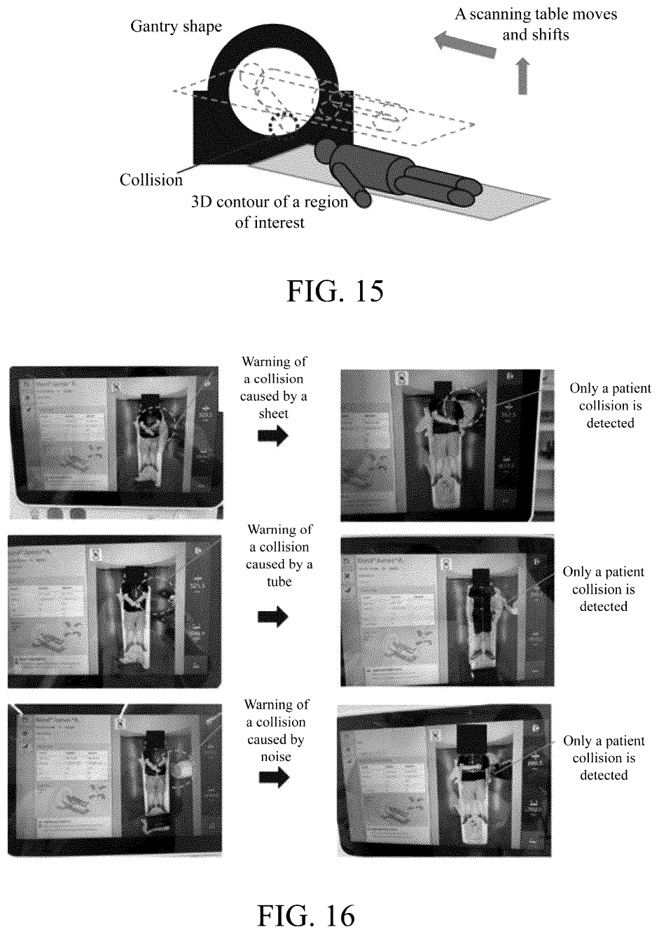

FIG. 14 illustrates an example block diagram of a computing device 1400 according to a technique of the present disclosure. The computing device 1400 may be implemented as an example of the computing device 216 shown in FIG. 2. The computing device 1400 includes one or a plurality of processors 1420; and a storage apparatus 1410, configured to store one or a plurality of programs, the one or plurality of programs, when executed by the one or plurality of processors 1420, causing the one or plurality of processors 1420 to implement the processes described in the present disclosure. The processor is, for example, a digital signal processor (DSP), a microcontroller, an application-specific integrated circuit (ASIC), or a microprocessor.

The computing device 1400 shown in FIG. 14 is merely an example, and should not impose any limitation on the function and usage scope of the embodiments of the present invention.

As shown in FIG. 14, the computing device 1400 is represented in the form of a general-purpose computing device. Components of the computing device 1400 may include, but are not limited to, one or a plurality of processors 1420, a storage apparatus 1410, and a bus 1450 connecting different system components (including the storage apparatus 1410 and the processor 1420).

The bus 1450 represents one or a plurality of types among several types of bus structures, including a memory bus or memory controller, a peripheral bus, a graphics acceleration port, a processor, or a local bus using any bus structure among the plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The computing device 1400 typically includes a plurality of types of computer system-readable media. These media may be any available medium that can be accessed by the computing device 1400, including volatile and non-volatile media as well as removable and non-removable media.

The storage apparatus 1410 may include a computer system readable-medium in the form of a volatile memory, for example, a random access memory (RAM) 1411 and/or a cache memory 1412. The computing device 1400 may further include other removable/non-removable, and volatile/non-volatile computer system storage media. Only as an example, a storage system 1413 may be configured to read/write a non-removable, non-volatile magnetic medium (not shown in FIG. 14, typically referred to as a “hard disk drive”). Although not shown in FIG. 14, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 1450 via one or a plurality of data medium interfaces. The storage apparatus 1410 may include at least one program product which has a group of program modules (for example, at least one program module) configured to perform the functions of the embodiments of the present invention.

A program/utility tool 1414 having a group (at least one) of program modules 1415 may be stored in, for example, the storage apparatus 1410. This program module 1415 includes, but is not limited to, an operating system, one or a plurality of application programs, other program modules, and program data, and each of these examples or a certain combination thereof may include an implementation of a network environment. The program module 1415 typically performs the function and/or method in any embodiment described in the present invention.

The computing device 1400 may also communicate with one or a plurality of external devices 1460 (such as a keyboard, a pointing device, and a display 1470), and may also communicate with one or a plurality of devices that enable a user to interact with the computing device 1400, and/or communicate with any device (such as a network card and a modem) that enables the computing device 1400 to communicate with one or a plurality of other computing devices. Such communication may be carried out via an input/output (I/O) interface 1430. Moreover, the computing device 1400 may also communicate, via a network adapter 1440, with one or a plurality of networks (for example, a local area network (LAN), a wide area network (WAN) and/or a public network, for example, the Internet). As shown in FIG. 14, the network adapter 1440 communicates, via the bus 1450, with other modules of the computing device 1400. It should be understood that although not shown in the figure, other hardware and/or software modules can be used in combination with the computing device 1400, including, but not limited to, microcode, device drivers, redundant processing units, external disk drive arrays, RAID systems, tape drives, data backup storage systems, and the like.

The processor 1420 executes, by running programs stored in the storage apparatus 1410, various functional applications and data processing, for example, implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or a plurality of aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically crasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In an example, the network interface device may include one or a plurality of physical jacks (for example, Ethernet, coaxial, or phone jacks) or one or a plurality of antennas for connection to the communication network. In an example, the network interface device may include a plurality of antennas that wirelessly communicate using at least one technique of single-input multiple-output (SIMO), multiple-input multiple-output (MIMO), or multiple-input single-output (MISO) techniques.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the imaging method and the imaging device according to the present invention have been described, and the computer-readable storage medium capable of implementing the method have also been described.

According to the techniques of the present disclosure, before examination is performed on the subject under examination, a potential site of collision of the subject under examination with the imaging device during the movement of the scanning table may be predicted, and this collision site may be subdivided. Thus, it can be accurately determined whether this collision is caused by the subject under examination or by an accessory or noise, and further, the operator can be assisted in determining whether an adjustment is required to avoid the collision or if the examination process can be continued, as shown in FIG. 16.

Some exemplary embodiments have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, device, or circuit are combined in other manners and/or replaced or supplemented with additional components or equivalents thereof; accordingly, the modified other implementations also fall within the protection scope of the claims.

1. An imaging method, comprising:
obtaining a global 3D contour image comprising an imaging device and a pre-identified object, wherein the pre-identified object comprises at least a part of a subject under examination;
predicting a potential collision pixel at which the pre-identified object will possibly collide with the imaging device in a process of being moved;
obtaining a contour image of the subject under examination;
determining whether the potential collision pixel falls within a range of the contour image of the subject under examination; and
in response to the aforementioned determination, generating a corresponding imaging operation prompt.

2. The method according to claim 1, wherein the pre-identified object further comprises an accessory of the imaging device.

3. The method according to claim 1, further comprising:
determining a scan range of interest from the global 3D contour image, wherein the scan range of interest comprises at least a region of interest of the subject under examination,
wherein the potential collision pixel is predicted only for the scan range of interest in the global 3D contour image.

4. The method according to claim 1, wherein predicting the potential collision pixel comprises:
converting coordinates of the pre-identified object from a coordinate system of a camera to a coordinate system of the imaging device; and
determining, based on coordinates of the pre-identified object after conversion and movement plan information of the subject under examination, whether the pre-identified object will overlap with a 3D contour of the imaging device in a process in which the pre-identified object is moved according to the movement plan information, wherein the 3D contour of the imaging device is obtained from the imaging device.

5. The method according to claim 4, further comprising: in response to determining that the potential collision pixel does not exist or the potential collision pixel does not fall within the range of the contour image of the subject under examination, moving the subject under examination based on the movement plan information.

6. The method according to claim 1, wherein determining whether the potential collision pixel falls within a range of the contour image comprises:
extracting a 2D contour image of the subject under examination from the global 3D contour image;
projecting the potential collision pixel onto the same 2D plane as the 2D contour image; and
determining whether a projection of the potential collision pixel on the 2D plane falls within a range of the 2D contour image of the subject under examination.

7. The method according to claim 6, wherein extracting a 2D contour image of the subject under examination comprises:
obtaining a global 2D contour image in the global 3D contour image;
determining, based on a probability value that each pixel in the global 2D contour image belongs to a part of a contour of the subject under examination, one or more regions in the global 2D contour image possibly belonging to a part of the contour of the subject under examination; and
filtering the one or more regions based on geometric information and position information to obtain the 2D contour image of the subject under examination.

8. The method according to claim 1, further comprising:
determining whether at least a part of the subject under examination is capable of being detected in the global 3D contour image; and
in response to determining that at least a part of the subject under examination is incapable of being detected, generating a corresponding imaging operation prompt.

9. The method according to claim 8, wherein determining whether at least a part of the subject under examination is capable of being detected in the global 3D contour image comprises: determining whether one or more key points of the subject under examination are capable of being detected, wherein the one or more key points indicate one or more anatomical positions of the subject under examination.

10. The method according to claim 1, wherein the imaging operation prompt comprises: visually presenting the potential collision pixel, or issuing a collision warning.

11. An imaging device, configured to visually examine a subject under examination, wherein the imaging device comprises:
a movable scanning table, configured to place a subject under examination;
a camera, configured to obtain a global 3D contour image comprising the imaging device and a pre-identified object, wherein the pre-identified object comprises at least a part of the subject under examination; and
a processing unit, wherein the processing unit is configured to be used to:
obtain the global 3D contour image;
predict a potential collision pixel at which the pre-identified object will possibly collide with the imaging device in a process of being moved;
obtain a contour image of the subject under examination;
determine whether the potential collision pixel falls within a range of the contour image of the subject under examination; and
in response to the aforementioned determination, generating a corresponding imaging operation prompt.

12. The imaging device according to claim 11, wherein the pre-identified object further comprises an accessory of the imaging device.

13. The imaging device according to claim 11, wherein the processing unit is further configured to be used to:
determine a scan range of interest from the global 3D contour image, wherein the scan range of interest comprises at least a region of interest of the subject under examination,
wherein the potential collision pixel is predicted only for the scan range of interest in the global 3D contour image.

14. The imaging device according to claim 11, wherein the processing unit is configured to predict the potential collision pixel via the following operations:
converting coordinates of the pre-identified object from a coordinate system of the camera to a coordinate system of the imaging device; and
determining, based on coordinates of the pre-identified object after conversion and movement plan information of the subject under examination, whether the pre-identified object will overlap with a 3D contour of the imaging device in a process in which the pre-identified object is moved according to the movement plan information, wherein the 3D contour of the imaging device is obtained from the imaging device.

15. The imaging device according to claim 14, wherein the processing unit is further configured to be used to: in response to determining that the potential collision pixel does not exist or the potential collision pixel does not fall within the range of a 2D contour image of the subject under examination, cause the imaging device to move the subject under examination based on the movement plan information.

16. The imaging device according to claim 11, wherein the processing unit is configured to determine, via the following operations, whether the potential collision pixel falls within the range of the contour image:
extracting a 2D contour image of the subject under examination from the global 3D contour image;
projecting the potential collision pixel onto the same 2D plane as the 2D contour image; and
determining whether a projection of the potential collision pixel on the 2D plane falls within a range of the 2D contour image of the subject under examination.

17. The imaging device according to claim 16, wherein the processing unit is configured to extract the 2D contour image of the target subject under examination via the following operations:
obtaining a global 2D contour image in the global 3D contour image;
determining, based on a probability value that each pixel in the global 2D contour image belongs to a part of a contour of the subject under examination, one or more regions in the global 2D contour image possibly belonging to a part of the contour of the subject under examination; and
filtering the one or more regions based on geometric information and position information to obtain the 2D contour image of the subject under examination.

18. The imaging device according to claim 11, wherein the processing unit is further configured to be used to:
determine whether at least a part of the subject under examination is capable of being detected in the global 3D contour image; and
in response to determining that at least a part of the subject under examination is incapable of being detected, generate a corresponding imaging operation prompt.
